(19) United States
(12) Patent Application Publication
(10) Pub. No.: US 2016/0275056 A1
(43) Pub. Date: Sep. 22, 2016

(54) Temporal Control of Visual Characteristics in Content

(71) Applicant: Adobe Systems Incorporated, San Jose, CA (US)

(72) Inventors: Rahul Dhaundiyal, Bangalore (IN); Amit Agarwal, Noida (IN)

(21) Appl. No.: 14/660,853

(22) Filed: Mar. 17, 2015

(51) Int. Cl. G06F 17/24; G06F 17/21; G06F 3/0484

(52) U.S. Cl. CPC G06F 17/24; G06F 3/04842; G06F 17/218

(57) ABSTRACT

Content temporal selection control techniques are described. In one or more implementations, a method is described of controlling temporal application of a visual characteristic to a document in a user interface of a computing device as part of one or more edits made to the document. Temporal application of a visual characteristic to the document in a user interface of a computing device is controlled as part of editing the document. One or more inputs are detected by the computing device as associating a visual characteristic with a portion of the document in the user interface. A level of intensity of the visual characteristic is iteratively reduced by the computing device automatically and without user intervention over a defined amount of time. The application of the visual characteristic to the portion of the document is removed by the computing device upon expiration of the defined amount of time.

### BACKGROUND

Users may interact with large items of content having numerous pages, such as documents, spreadsheets, slide presentations, and so on. As part of this interaction, a user may markup portions of interest. For example, a user may highlight a section of text when writing a user's manual in order to refer back to that portion for context at a later point in time.

However, conventional techniques used to perform this highlighting or markups changed the underlying content itself and therefore become a part of this content. Accordingly, to remove these markups a user is forced in conventional techniques to manually go back to that portion of the content to remove the markups to return it “back to normal.” This problem could also be exacerbated in situations in which the document is large, e.g., has numerous pages, and thereby make it difficult for the user to find these marked-up portions later. Accordingly, conventional techniques could result in user frustration and unintended inclusion of markups when the document is disseminated.

### SUMMARY

Content temporal selection control techniques are described. In one or more implementations, a method is described of controlling temporal application of a visual characteristic to a document in a user interface of a computing device as part of one or more edits made to the document. Temporal application of a visual characteristic to the document in a user interface of a computing device is controlled as part of editing the document. One or more inputs are detected by the computing device as associating a visual characteristic with a portion of the document in the user interface. A level of intensity of the visual characteristic is iteratively reduced by the computing device automatically and without user intervention over a defined amount of time. The application of the visual characteristic to the portion of the document is removed by the computing device upon expiration of the defined amount of time.

In one or more implementations, a system is described of controlling temporal application of markups to content in a user interface. The system includes at least one module implemented at least partially in hardware, the at least one module configured to output the content in the user interface. The system also includes one or more modules implemented at least partially in hardware. The one or more modules are configured to respond to detection of one or more inputs that markup a portion of content in a user interface and iteratively reduce a level of intensity of the markup over a defined amount of time.

In one or more implementations, a computing device includes a processing system and computer-readable storage media comprising instructions stored thereon that, responsive to execution by the processing system, causes the processing system to perform operations. The operations includes detecting one or more inputs defining a portion of content in a user interface, responsive to the detecting, causing application of color to the defined portion of the content in the user interface, and iteratively reducing a level of intensity of the application of the color by the computing device over a defined amount of time.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ temporal control of visual characteristic techniques described herein.

FIG. 2 depicts a system in an example implementation showing iterative reduction in a level of intensity over a defined amount of time of a visual characteristic associated with a portion of a user interface of FIG. 1.

FIG. 3 depicts a system in an example implementation showing iterative reduction in a level of intensity over a defined amount of time of a visual characteristic associated with a portion of the user interface of FIG. 1 that is defined using implicit techniques.

FIG. 4 depicts an example implementation of the temporal visual characteristic techniques that support navigation functionality.

FIG. 5 depicts an example implementation of a user interface configured to support user interaction to specify settings for use as part of the temporal control of visual characteristics.

FIG. 6 is a flow diagram depicting a procedure in an example implementation in which a level of intensity of a visual characteristic associated with a portion of content in a user interface is iteratively reduced.

FIG. 7 illustrates an example system including various components of an example device that can be implemented as any type of computing device as described and/or utilize with reference to FIGS. 1-6 to implement embodiments of the techniques described herein.

### DETAILED DESCRIPTION

Overview

Conventional techniques used to markup a portion of content (e.g., highlighting a portion of text in a document, circling an object in an image using a stylus, and so on) become a part of the content itself. Consequently, these techniques could interfere with the underlying content and require manual interaction on a part of a user to remove the markups from the content, which could also result in unintended permanent inclusion of the markups. Further, these conventional markups are registered as a change to the content by an application. Accordingly, markups could cause the application to prompt a user regarding inclusion of the change upon closure, e.g., “do you want to save the changes to the document,” forcing a user to manually determine which changes are intended to persist or be discarded.

In another conventional example, heat maps have been used in the field of analytics for web pages. The heat maps use colors that are conventionally overlaid on text and other elements of a webpage to indicate an amount of user interaction, e.g., number of clicks, a result of tracking of a cursor control device, and so on. In this example, however, the web pages are permanently colored to show this interaction, which requires manual removal by a user or requires a change in the represented statistics, e.g., number of clicks. In a further conventional example, animations are used in slideshow presentations to fade in and/or fade out graphical elements. Thus, each of these conventional examples involve permanent changes to the underlying content, which may be difficult to remove manually by a user.

Techniques involving temporal control of visual characteristics in content are described. In one or more implementations, visual characteristics are associated with a portion of content in a user interface. A user, for instance, may select a control to initiate the temporal control, such as to select a button, right-click a mouse, perform a gesture, make a verbal utterance, and so forth. The user then highlights a portion of text, circle an object in a drawing using a freeform line, and so on in a graphical user interface (e.g., a view window, desktop, menu, and so forth) that is intended as a temporary markup associated with a portion of the content. A computing device then iteratively reduces a level of intensity of the visual characteristic over a defined amount of time, after which the visual characteristic is automatically removed from display in the user interface. A user, for instance, may highlight a portion of text that is to be referred to later (such as to make a temporary note), perform a cut-and-paste operation, and so forth. A color of the highlighting is then configured by the computing device to fade over time through use of a timer, as specified by a user setting, and so on until a point is reached at which the highlighting is no longer displayed in the user interface.

In this way, the visual characteristics are controlled automatically and without user intervention by the computing device. Further, these visual characteristics are maintained separately from the content and thus do not become an actual part of the content, e.g., when saving the content, and thus do not prompt a “do you want to save these changes” dialog box or cause unintended inclusion in a disseminated version of the document. Further discussion of these and other examples is described in the following sections and shown in corresponding figures.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

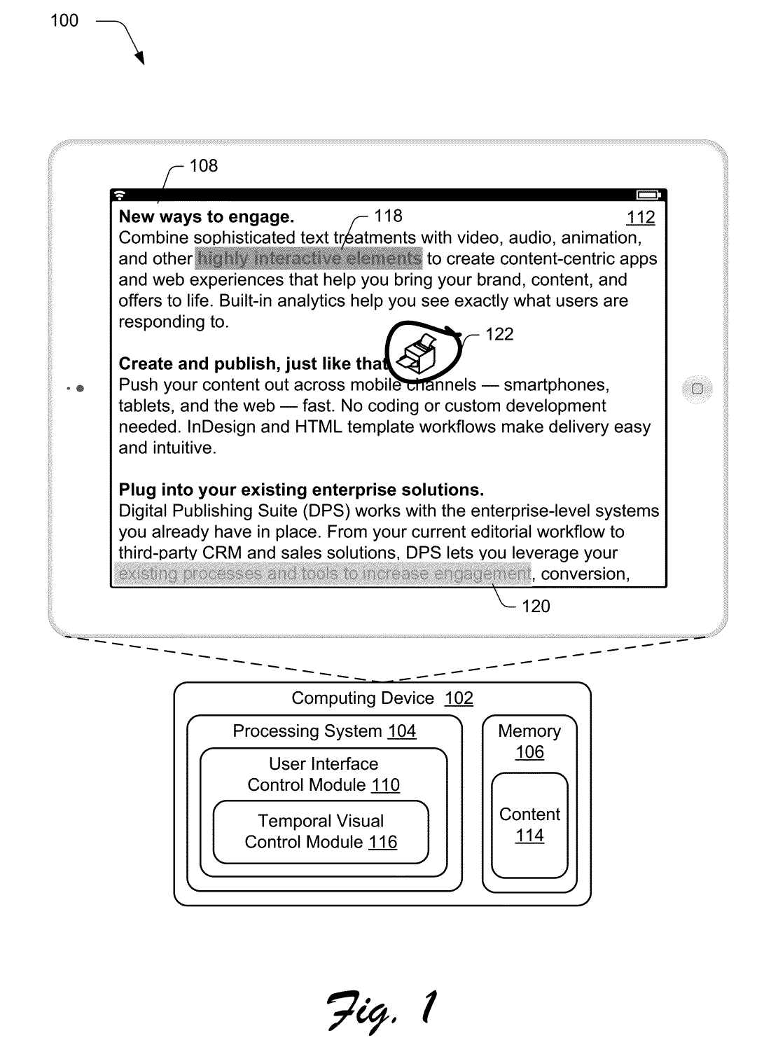

FIG. 1 is an illustration of an environment 100 in an example implementation that is operable to employ techniques described herein. The illustrated environment 100 includes a computing device 102, which may be configured in a variety of ways.

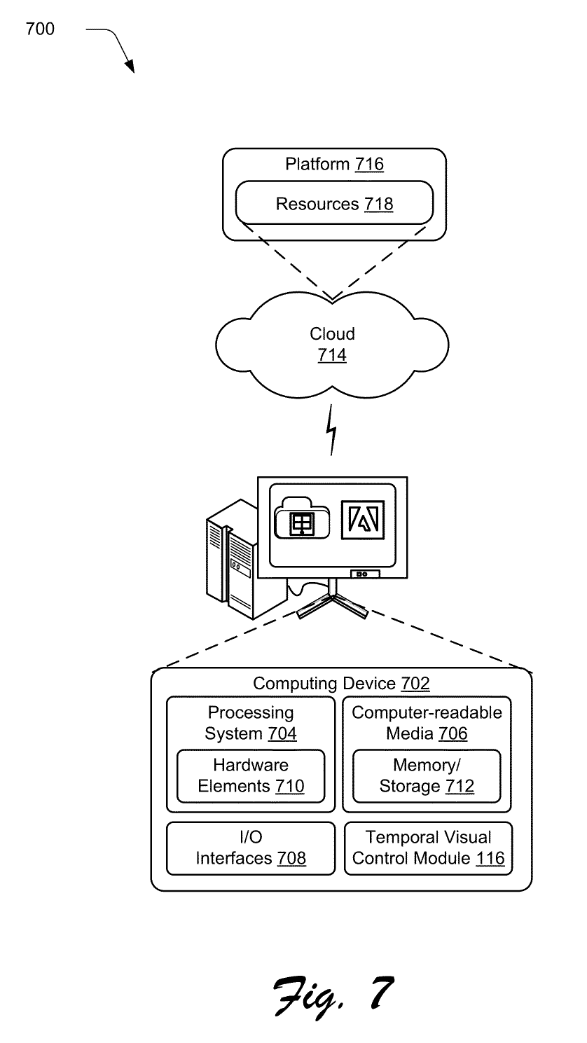

The computing device 102, for instance, may be configured as a desktop computer, a laptop computer, a mobile device (e.g., assuming a handheld configuration such as a tablet or mobile phone as illustrated), and so forth. Thus, the computing device 102 may range from full resource devices with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices, such as multiple servers utilized by a business to perform operations “over the cloud” as further described in relation to FIG. 7.

The computing device 102 is illustrated as including a variety of hardware components, examples of which include a processing system 104, an example of a computer-readable storage medium illustrated as memory 106, a display device 108, and so on. The processing system 104 is representative of functionality to perform operations through execution of instructions stored in the memory 106. Although illustrated separately, functionality of these components may be further divided, combined (e.g., on an application specific integrated circuit), and so forth.

The processing system 104 is illustrated as executing a user interface control module 110, which is storable in the memory 106. The user interface control module 110 is representative of functionality of the computing device 102 to generate and manage interaction with a user interface 112 displayed by the display device 108. For example, a user may use a keyboard, cursor control device, gesture detected by touchscreen functionality of the display device 108, verbal utterance, and so on to interact with text or other objects displayed as part of content 114 by the display device 108. Content 114 can take a variety of forms, such as include text, visual objects, spreadsheets, as a document, a multimedia content, slide presentation, and so on.

The user interface control module 110 is illustrated as including a temporal visual control module 116. The temporal visual control module 116 is representative of functionality to manage inclusion of visual characteristics that are associated with a portion of the content 114 displayed in the user interface 112 by the display device 108. A user for instance, may select text included as part of the content and associate a visual characteristic with the text, such as highlighting 118, 120. In another example, a user inputs a freeform line 122 to circle an object, e.g., an image of a printer in the illustrated example. Thus, in this instance each of these visual characteristics act as a markup to an associated portion of the content 114.

In one or more implementations, the temporal visual control module 116 is configured to manage these visual characteristics (e.g., markups) separately from the content 114 such that the visual characteristics do not become a persistent part of the content 114. For example, these visual characteristics are managed such that an application causing output of the content 114 does not recognize the visual characteristics as changes to the content 114 but rather are maintained separately from the content, e.g., as part of metadata associated with the content, as a separate file maintained by the temporal visual control module 116 separately from the storage of content 114 in memory, and so forth. Therefore, if the content 114 is saved the visual characteristics are not saved as a persistent part of the content 114. Further, if a user opens the content 114 and solely inputs the visual characteristics controlled by the temporal visual control module 116, the user is not prompted in this example to persist these visual characteristics. Other implementations are also contemplated, however, in which the visual characteristics are persisted, and/or an option is provided to persist the visual characteristics, which may also be maintained separately from the content 114. Therefore, dissemination of the content 114 does not include the changes.

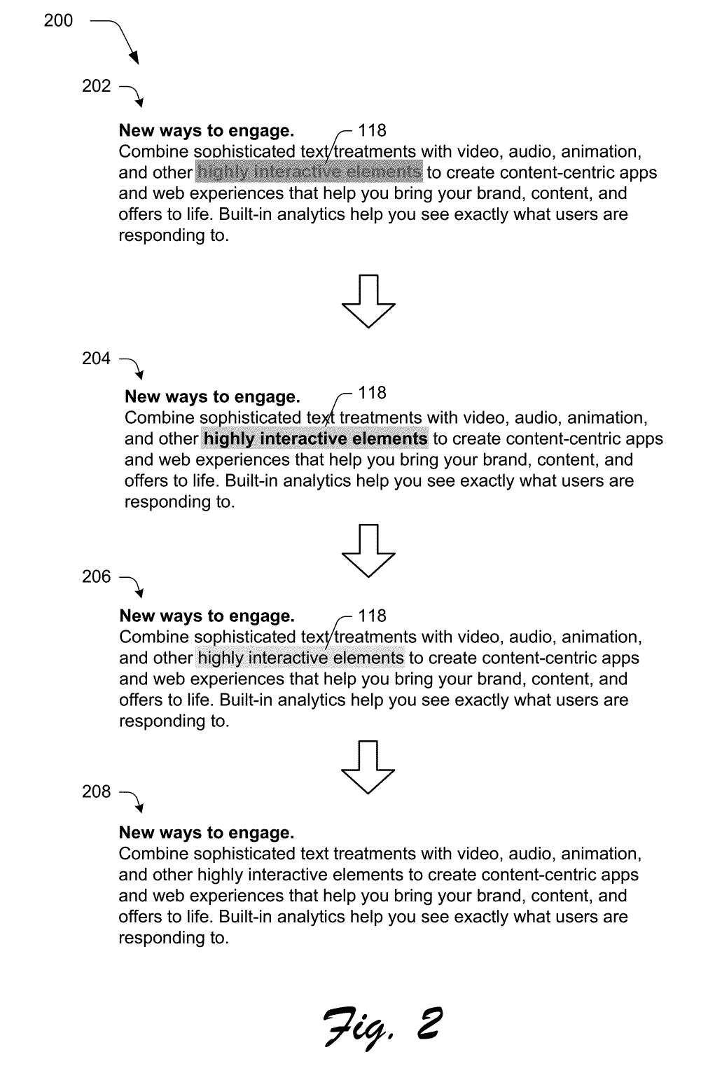

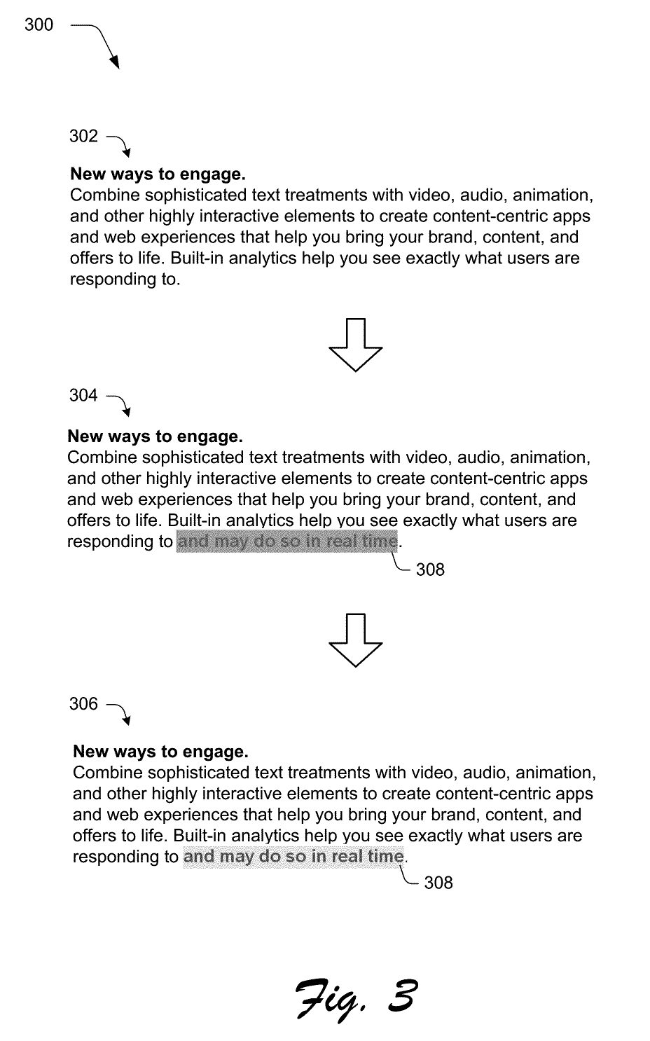

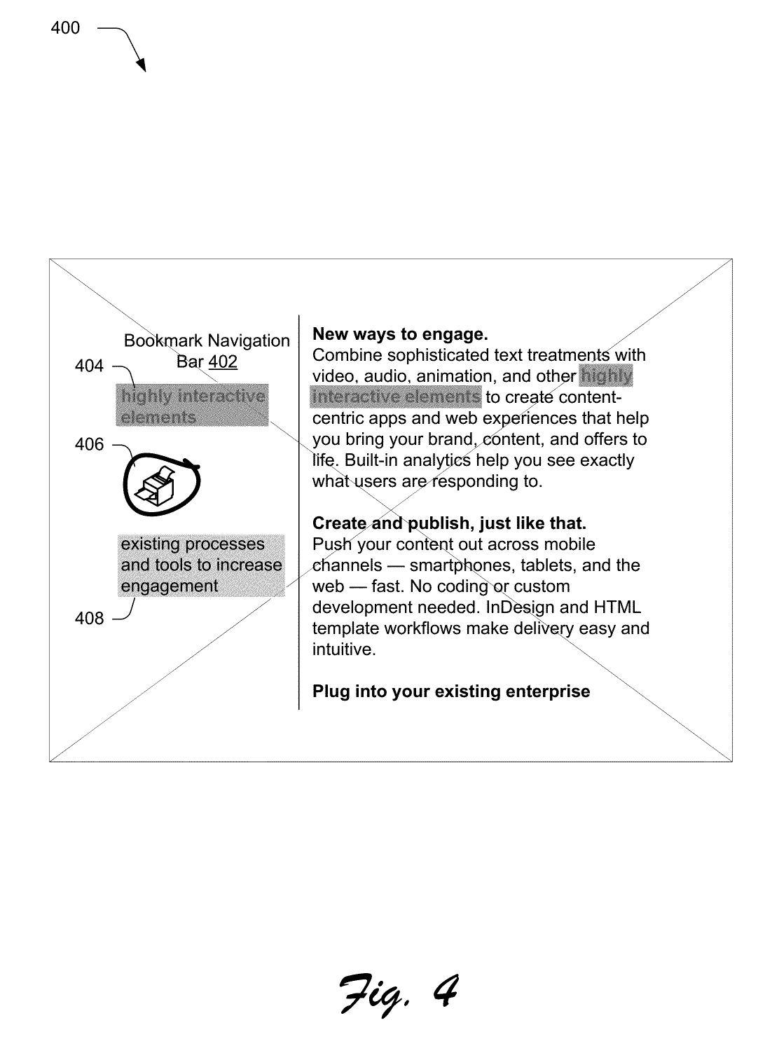

The temporal visual control module 116 is also configured to decrease a level of intensity, based on default setting or user defined setting or dynamically calculated based on certain parameters such as time of application of visual characteristic, time since document is opened, detection of completion of workflow for which visual characteristic was created, and so on of the visual characteristic and thus indicate to a user a relative amount of time the visual characteristic has been displayed (e.g., which also is indicative of when input) and also a relative amount of time the visual characteristic will remain displayed. This may be performed as part of a variety of different workflows, such as highlighting as shown in FIG. 2, a cut-and-paste operation as shown in FIG. 3, a freeform line as shown in FIG. 4, and so forth. Additionally, amounts used in the decrease in intensity may be defined in a variety of ways, such as linearly or non-linearly, a user-defined value, and so forth as described in further detail below.

In the illustrated example, a level of intensity of the highlighting 118 is greater than a level of intensity of the highlighting 120 and thus indicates that the text “highly interactive elements” was highlighted more recently than the text “existing processes and tools to increase engagement.” In this example, the text “highly interactive elements” is also bolded while the text “existing processes and tools to increase engagement” is not, which is also indicative of a decrease in level of intensity as an amount of time grows since association of the visual characteristic with the portion of the content 114.

Thus, the temporal visual control module 116 is configured to decrease a level of intensity of the visual characteristics over a defined amount of time. This may be done by decrease in a level of intensity of a color, use of different shades of a color, use of different colors in the highlighting 118, 120 examples. Other visual characteristics may include use of bolding as illustrated, underlying, italicizing, change in display size, and so forth. Similar techniques are also usable for other visual characteristics, such as the freeform line 122, e.g., by decrease in color, width, increase in transparency, decrease in shading, and so forth. Further discussion of these and other examples is described in the following and shown in corresponding figures.

FIG. 2 depicts a system 200 in an example implementation showing iterative reduction in a level of intensity over a defined amount of time of a visual characteristic associated with a portion of the user interface 112 of FIG. 1. The system 200 is illustrated using first, second, third, and fourth stages 202, 204, 206, 208. In this example, one or more inputs are associated with a portion of the content in the user interface explicitly through selection of the portion of the content 114 by a user that is detected by the computing device 102 of FIG. 1.

At the first stage 202, for instance, a user selects the text “highly interactive elements” to highlight 118 the text and thus associates a visual characteristic (e.g., the highlighting) with the text. Other visual characteristics may also be associated with this text, such as bolding in the illustrated example. This may be performed by modifying the text of the content 114 itself or without modification, e.g., such as to display bolding “over” the underlying text as the visual characteristic such that the bolding is maintained separately from the content 114.

At the second stage 204, a level of intensity of the visual characteristic, e.g., the highlighting 118, is reduced by the temporal visual control module 116. This is performable in a variety of ways. For example, the temporal visual control module 116 may reduce an amount of the color displayed in the user interface (e.g., by adjusting a transparency setting), change a shade of the color display in the user interface, change a color itself, and so forth.

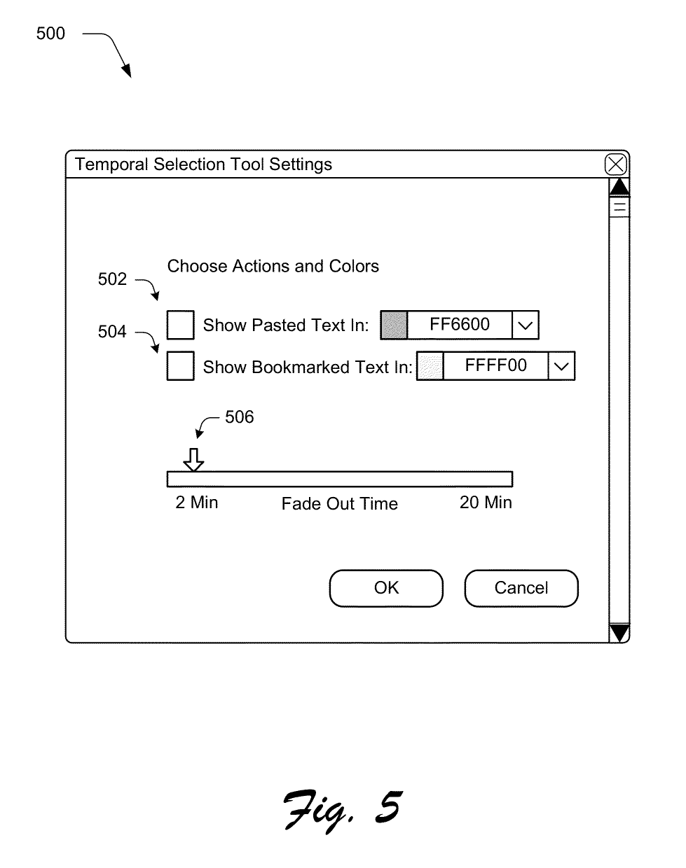

At the third stage 206, the temporal visual control module 116 iterates the reduction in the level of intensity of the visual characteristic, e.g., by further reducing an amount of the color, change of shade, color, and so on. In this example, the level of intensity of the color is further reduced along with removal of the bolding of the text. In this way, the visual characteristic is configured to fade over a defined amount of time, such as specified by a user and/or application, further discussion of which is described in relation to FIG. 5.

At the fourth stage 208, the application of the visual characteristic to the portion of the content is removed by the temporal visual control module 116 upon expiration of the defined amount of time. Thus, in this example the visual characteristic is configured to fade over the defined amount of time, after which the visual characteristic is removed from the user interface 112. The amount of decrease in the level of intensity is definable in a variety of ways, such as linearly over the defined amount of time or nonlinearly, e.g., in a quadratic fashion starting with a slow reduction that increases as the defined amount of time increases. Implicit detection mechanisms are also contemplated, further discussion of which is described in the following and shown in a corresponding figure.

FIG. 3 depicts a system 300 in an example implementation showing iterative reduction in a level of intensity over a defined amount of time of a visual characteristic associated with a portion of the user interface 112 of FIG. 1 that is defined using implicit techniques. The system 300 is illustrated using first, second, and third stages 302, 304, 306. In this example, one or more inputs are associated with a portion of the content in the user interface implicitly.

At the first stage 302, for instance, text taken from the content 114 of FIG. 1 is shown. At the second stage 304, the text 308 “and may do so in real time” is added to the existing text, e.g., as a “paste”. In response, the temporal visual control module 116 associates this added portion of content with a visual characteristic 308 (e.g., in response to selection by a user of a setting to indicate a cut-and-paste operation through use of the temporal control, a user interface control to initiate temporal highlighting, and so forth), such as highlighting and bolding as described in relation to FIG. 3.

As shown at the third stage 306, the temporal visual control module 116 then repeats the iterative reduction of the level of intensity of the visual characteristic and may result in eventual removal of the characteristic after a defined amount of time. Thus, in this example inputs involving addition of the text to the user interface 112 is inferred by the temporal visual control module 116 as selection of that portion of the content to associate a visual characteristic therewith.

FIG. 4 depicts an example implementation 400 of the temporal visual characteristic techniques that support navigation functionality. As previously described, the visual characteristics may be used to help a user relocate a desired portion of content 114 of interest. This may be performed by scrolling through a document, use of page up or page down buttons on a keyboard, and so on as traditionally performed to navigate through content.

In this example, however, the visual characteristic itself is configured to support efficient location by a user. A bookmark navigation bar 402, for instance, is configured to include representations 404, 406, 408 of visual characteristics that have been associated with portions of content 114 as described above. The bookmark navigation bar 402, for instance, may be output as a menu that is maintained by the temporal visual control module 116 to include representations of current visual characteristics, e.g., highlighting, freeform lines, cut-and-pastes, and so forth as described above. Selection of the representations cause navigation to the corresponding portion of the content 114 by the temporal visual control module 116. An example of this is illustrated as selection of representation 404 to navigate to the portion of the content “highly interactive elements”

As is also illustrated, association of the visual characteristic with the portion of the content may be performed to support a variety of layouts. The text “highly interactive elements” in FIG. 1, for instance, is included on a single line. When reflowed to fit a layout of FIG. 4, the visual characteristic remains associated with that portion of the content. Other examples are also contemplated.

FIG. 5 depicts an example implementation of a user interface 500 configured to support user interaction to specify settings for use as part of the temporal control of visual characteristics. The user interface 500 in this example is for controlling visual settings of the temporal content via dialog/menu. The menu/dialog includes an option 502 to select a visual characteristic (e.g., color) for “Pasted Text” and an option 504 to select a visual characteristic (also color) for “Bookmarked Text” as shown in FIG. 4.

An option 506 is also provided, via which, a user may specify the defined amount of time over which the level of intensity of the visual characteristic is to be reduced before removal. In this way, the visual characteristics may be used to “heat up” a portion of selected content which is then cooled and removed from the user interface automatically and without user intervention. Further discussion of these and other examples is contained in the following section.

Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-5.

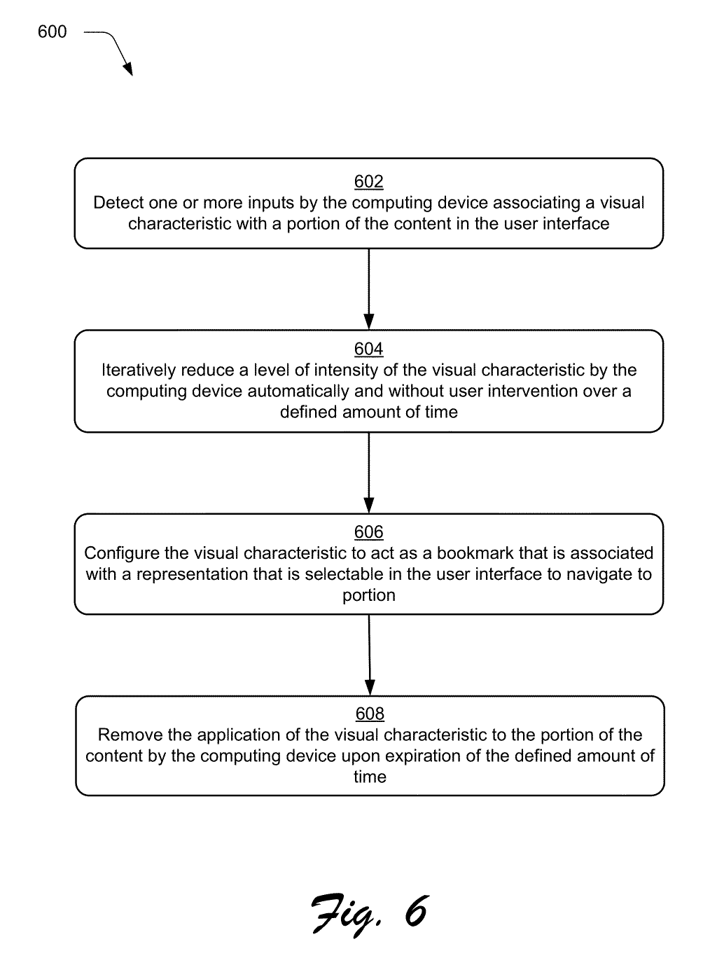

FIG. 6 depicts a procedure 600 in an example implementation in which a level of intensity of a visual characteristic associated with a portion of content in a user interface is iteratively reduced. One or more inputs are detected by the computing device as associating a visual characteristic with a portion of the content in the user interface (block 602). A user, for instance, may circle an object displayed on a display device 108 using a gesture, highlight a portion of text, may use a cursor control device to draw a freeform line around a paragraph, perform a cut-and-paste operation, and so on.

A level of intensity of the visual characteristic is iteratively reduced by the computing device automatically and without user intervention over a defined amount of time (block 604). The level of intensity, for instance, may be reduced through successive decreases in an amount of color, shade of a color (e.g., progressively darker), line width, transparency, and so on.

The visual characteristic is configured to act as a bookmark that is associated with a representation that is selectable in the user interface to navigate to the portion (block 606). For example, selection of the portion of the content 114 may cause that selection to act as a bookmark such that selection of a representation of the selection causes navigation to the corresponding portion of the content.

The application of the visual characteristic to the portion of the content is removed by the computing device upon expiration of the defined amount of time (block 608). In this way, the visual characteristics is removed automatically and without user intervention. A variety of other examples are also contemplated as previously described.

Example System and Device

FIG. 7 illustrates an example system generally at 700 that includes an example computing device 702 that is representative of one or more computing systems and/or devices that may implement the various techniques described herein. This is illustrated through inclusion of the temporal visual control module 116. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method of controlling temporal application of a visual characteristic to a document in a user interface of a computing device as part of one or more edits made to the document, the method comprising:
detecting one or more inputs by the computing device associating a visual characteristic with a portion of the document in the user interface as part of editing the document;
iteratively reducing a level of intensity of the visual characteristic by the computing device automatically and without user intervention over a defined amount of time; and
automatically removing the application of the visual characteristic to the portion of the document by the computing device upon expiration of the defined amount of time.

2. A method as described in claim 1, wherein the one or more inputs are associated with the portion of the document in the user interface explicitly through selection of the portion of the document by a user that is detected by the computing device.

3. A method as described in claim 1, wherein the one or more inputs are associated with the document of the content in the user interface implicitly through addition of the portion of the document to the user interface.

4. A method as described in claim 1, wherein the one or more inputs include a freeform line, highlighting, or selection of text or an object in the user interface.

5. A method as described in claim 1, wherein the visual characteristic includes a color and the iteratively reducing the level of intensity includes reducing an amount of the color displayed in the user interface or changing a shade of the color displayed in the user interface.

6. A method as described in claim 1, further comprising configuring the visual characteristic to act as a bookmark that is associated with a representation that is selectable in the user interface to navigate to portion.

7. A method as described in claim 1, further comprising responding to an input to save the content by storing the document without the visual characteristic.

8. A method as described in claim 1, wherein the iteratively reducing the level of intensity is not performed linearly over time.

9. A method as described in claim 1, wherein the defined amount of time is specified by a user through interaction with one or more settings of the user interface.

10. A method as described in claim 1, wherein the visual characteristic is specified by a user through interaction with one or more settings of the user interface.

11. A system of controlling temporal application of markups to content in a user interface, the system comprising:
at least one module implemented at least partially in hardware, the at least one module configured to output the content in the user interface; and
one or more modules implemented at least partially in hardware, the one or more modules configured to respond to detection of one or more inputs that markup a portion of content in a user interface and iteratively reduce a level of intensity of the markup over a defined amount of time.

12. A system as described in claim 11, wherein the one or more modules are further configured to configure the markup to act as a bookmark that is associated with a representation that is selectable in the user interface to navigate to markup.

13. A system as described in claim 11 wherein the one or more modules are further configured to respond to an input to save the content by storing the content without the markup.

14. A system as described in claim 11, wherein the one or more inputs define the markup explicitly through selection of a portion of the content by a user or implicitly through addition of the portion of the content to the user interface.

15. A system as described in claim 11, wherein the markup includes a color and the iterative reduction of the level of intensity includes reducing an amount of the color displayed in the user interface or changing a shade of the color displayed in the user interface.

16. A computing device comprising:
a processing system; and
computer-readable storage media comprising instructions stored thereon that, responsive to execution by the processing system, causes the processing system to perform operations comprising:
detecting one or more inputs defining a portion of content in a user interface;
responsive to the detecting, causing application of color to the defined portion of the content in the user interface;
iteratively reducing a level of intensity of the application of the color by the computing device over a defined amount of time.

17. A computing device as described in claim 16, wherein the operations further comprise configuring the portion of the content to act as a bookmark that is associated with a representation that is selectable in the user interface to navigate to portion.

18. A computing device as described in claim 16, wherein the operations further comprise responding to an input to save the content by storing the content without the visual characteristic.

19. A computing device as described in claim 16, wherein the one or more inputs define the portion of the content in the user interface explicitly through selection of the portion of the content by a user or implicitly through addition of the portion of the content to the user interface.

20. A computing device as described in claim 16, wherein the iterative reduction of the level of intensity includes reducing an amount of the color displayed in the user interface or changing a shade of the color displayed in the user interface.
